(19) United States
(12) Patent Application Publication
(10) Pub. No.: US 2011/0094388 A1
(43) Pub. Date: Apr. 28, 2011

(54) FLUID GENERATION SYSTEM

(75) Inventors: Chuck N. Stanley, Colleyville, TX (US); Kevin D. Kuykendall, Dallas, TX (US); Michael B. Robeson, Arlington, TX (US)

(73) Assignee: Health2oProducts, LLC, Dallas, TX (US)

(21) Appl. No.: 12/910,105

(22) Filed: Oct. 22, 2010

Related U.S. Application Data
(60) Provisional application No. 61/254,111, filed on Oct. 22, 2009.

(51) Int. Cl. C12C 11/00

(52) U.S. Cl. 99/276

(57) ABSTRACT

Provided is a fluid generation system including an inlet fluid manifold coupleable to an inlet fluid source, and a feed manifold coupled to an output of a feeding/mixing system. Further included may be two or more fermentation units and two or more blending units. An inlet and outlet of each of the fermentation units may be coupled to the feed manifold and concentrate fluid manifold, respectively. Furthermore, a first inlet of each of the blending units may be coupled to the concentrate fluid manifold and a second inlet of each of the blending units may be coupled to the inlet fluid manifold, and an outlet of each of the blending units may be coupleable to an outlet fluid source. The fluid generation unit, in this embodiment, may also includes a controller for controlling a flow of fluid between the manifolds and fermentation and blending units.

### CROSS-REFERENCE TO RELATED APPLICATION

This application claims the benefit of U.S. Provisional Application Ser. No. 61/254,111, on Oct. 22, 2009, to Chuck Stanley, et al. entitled “FLUID GENERATION SYSTEM,” commonly assigned with this application and incorporated herein by reference.

### TECHNICAL FIELD

This application is directed, in general, to a fluid generation system and, more specifically, to a fluid generation system employing a collection of fermentation units and blending units.

### BACKGROUND

The specialty water/soft drink manufacturing industry is a competitive and often high margin, industry. Accordingly, the design of a new desirable product, method of manufacture therefore, or system for preparing such a product can quickly increase ones share of the marketplace.

### SUMMARY

One aspect provides a fluid generation system. The fluid generation system, in one example, includes an inlet fluid manifold coupleable to an inlet fluid source, as well as a feed manifold coupled to an output of a feeding/mixing system. The fluid generation system, in this embodiment, further includes two or more fermentation units, wherein an inlet of each of the two or more fermentation units is coupled to the feed manifold and an outlet of each of the two or more fermentation units is coupled to a concentrate fluid manifold. The fluid generation system, in this embodiment, additionally includes two or more blending units, wherein a first inlet of each of the two or more blending units is coupled to the concentrate fluid manifold and a second inlet of each of the two or more blending units is coupled to the inlet fluid manifold, and furthermore wherein an outlet of each of the two or more blending units is coupleable to an outlet fluid source. The fluid generation unit, in this embodiment, also includes a controller for controlling/monitoring a flow of fluid from the feed manifold to the two or more fermentation units and a flow of fluid from the concentrate fluid manifold and inlet fluid manifold to the two or more blending units, respectively.

### BRIEF DESCRIPTION

Reference is now made to the following descriptions taken in conjunction with the accompanying drawings, in which:

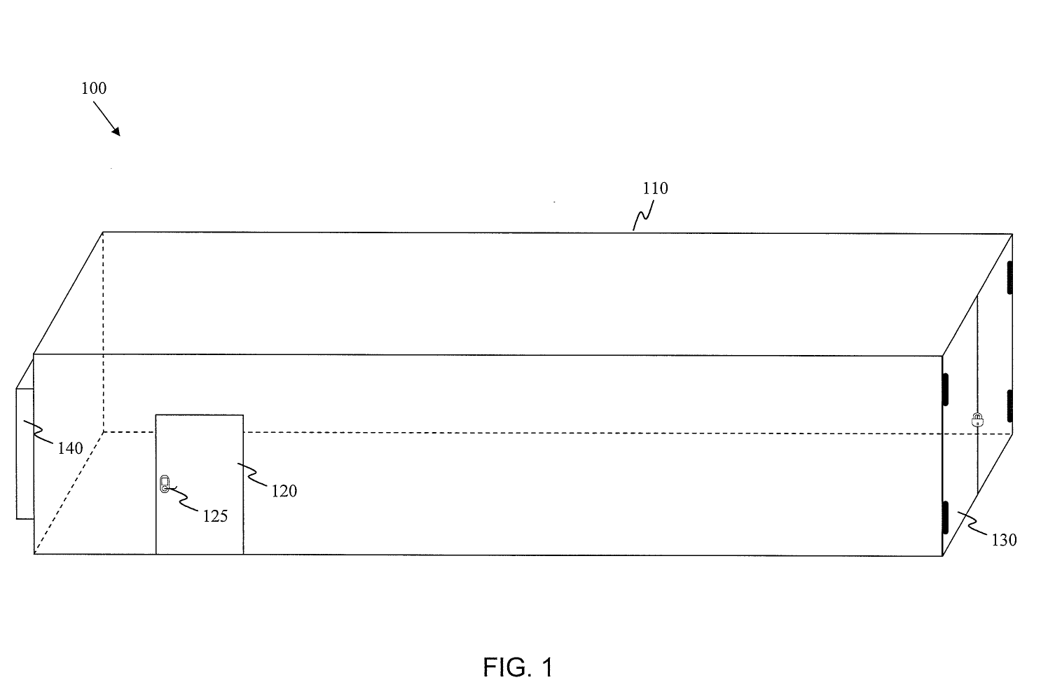

FIG. 1 is a plan view of fluid generation system provided in accordance with the disclosure;

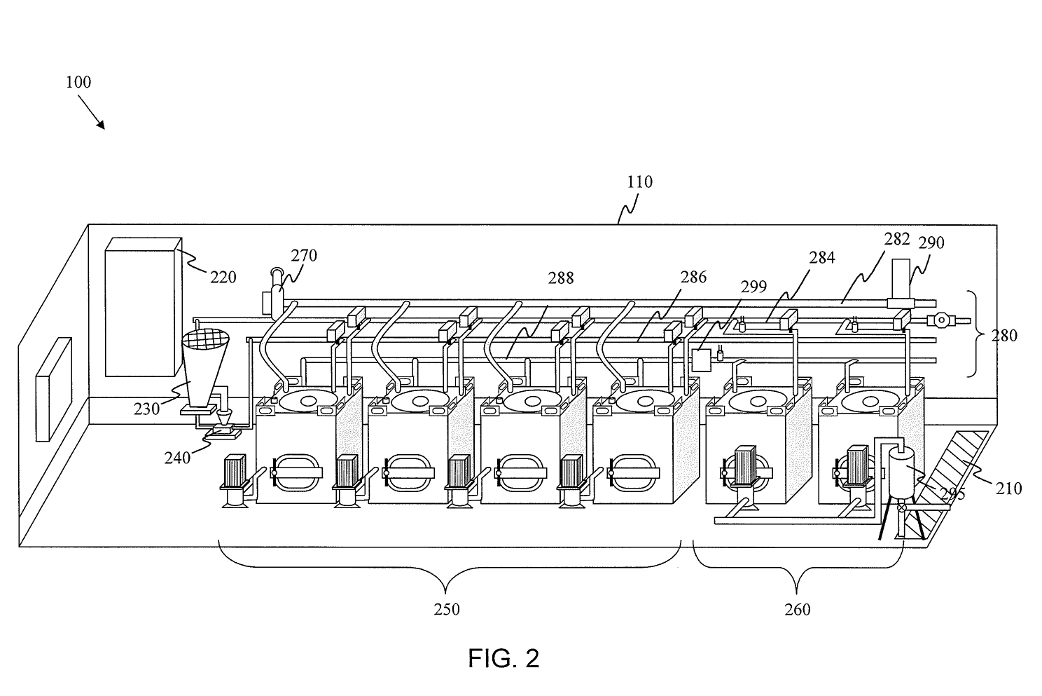

FIG. 2 is a cut-away view of the inside of the fluid generation system of FIG. 1;

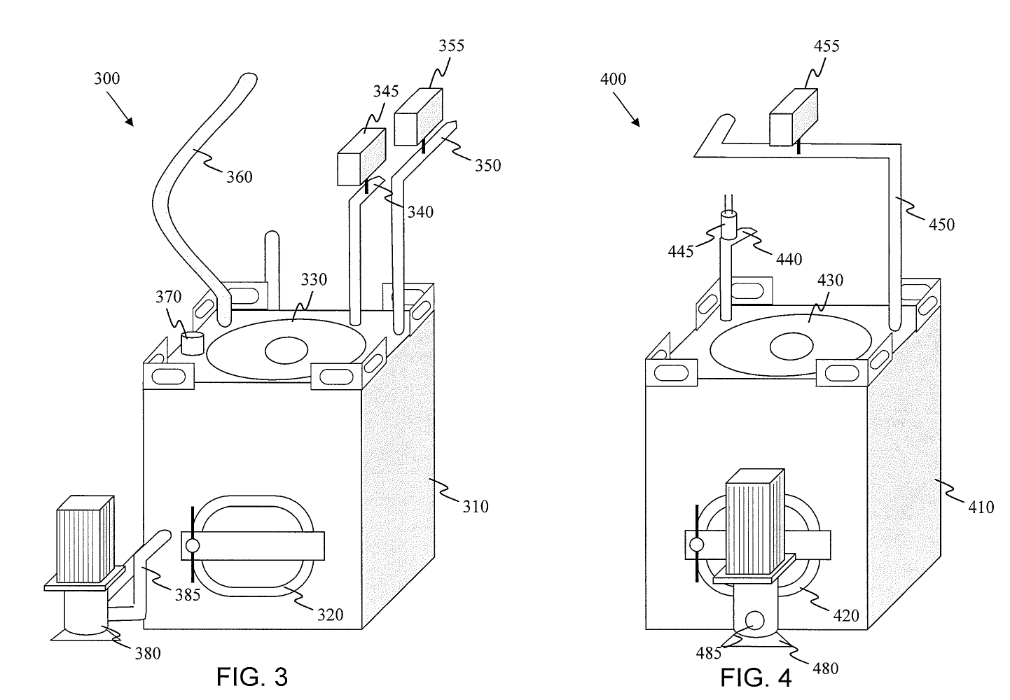

FIG. 3 is an expanded view of a fermentation unit, which might be similar to one of the fermentation units of FIG. 2; and

FIG. 4 is an expanded view of a blending unit, which might be similar to one of the blending units of FIG. 2.

### DETAILED DESCRIPTION

Referring initially to FIG. 1, illustrated is a plan view of fluid generation system 100 provided in accordance with the disclosure. The fluid generation system 100 of FIG. 1 initially includes a secure access container 110. The secure access container 110 of FIG. 1. comprises a Conex type container. For example, the secure access container 110 might comprise a 40′ L×8′ W×9.5′ H Conex type shipping container. Other types of secure access containers, different from Conex type containers, are within the scope of the disclosure.

The secure access container 110, as is shown in FIG. 1, may be entered through the door 120. In the embodiment of FIG. 1, the door 120 includes a security mechanism 125. For example, the security mechanism 125 could comprise a standard key operated lock, a more secure fingerprint operated lock, or like in the embodiment shown in FIG. 1, a dual security lock requiring two or more forms of identification (e.g., a key, a fingerprint, a code, etc.) Likewise, the security mechanism 125 may be monitored offsite, such that the date, time and identity of any person entering the secure access container 110 can be logged.

The secure access container 110 further includes alternate access points 130, in this instance one or more doors at the end thereof. In many instances, the alternate access points 130 will be fixed closed, such that they will not be used except in extreme circumstances, such as needing to replace/repair the larger features within the secure access container 110.

The secure access container 110 of FIG. 1 further includes a heating/cooling unit 140 coupled thereto. The heating/cooling unit 140, as well as insulation within the walls thereof, may be used to keep the temperature within the secure access container 110 within a prescribed range. For example, an R-value ranging from about 6 to 12 might be used within the walls of the secure access container 110. As for the tonnage of the heating/cooling unit 140, said tonnage will largely relate to the ultimate geographical location that the fluid generation system 100 will be placed, and thus may vary from unit to unit. Nevertheless, the heating/cooling unit 140 of FIG. 1 comprises a 2.5 ton HVAC unit.

Turning to FIG. 2, illustrated is a cut-away view of the inside of the fluid generation system 100. The inside bottom surface of the secure access container 110, in the embodiment of FIG. 2, functions as a tub to collect any fluid that may escape from any of the containers located therein. Likewise, the secure access container 110 may include a drain system 210. In the embodiment of FIG. 2, the drain system 210 is located near the alternative access points 130. Accordingly, the floor of the secure access container 110 may be manufactured so as to slope towards the drain system 210 when in use, or alternatively the entire fluid generation system 100 may be tilted toward the drain system 210, for example by having it rest upon a raised footing.

The fluid generation system 100 illustrated in FIG. 2 further includes a controller 220, a feeding system 230, a mixing system 240, as well as one or more fermentation units 250 and one or more blending units 260. Likewise, the fluid generation system 100 may include a ventilation system 270, a plurality of fluid manifolds 280 (e.g., exhaust manifold 282, inlet fluid manifold 284, feed manifold 286, concentrate fluid manifold 288), and incoming and outgoing fluid filters, 290, 295, respectively.

The fluid generation system, in one embodiment, additionally includes a filtration/UV irradiation system 299, for example positioned in the concentrate fluid manifold 288 between the fermentation units 250 and the blending units 260. The filtration/UV irradiation system 299, in this embodiment, includes a first filtration portion and a second UV irradiation portion. The first filtration portion, in this embodiment, might comprise a filter, for example similar to the filters 290, 295 disclosed above. Accordingly, the first filtration portion might be configured to remove suspended solids or particles larger than about 0.5 microns from the concentrate fluid of the concentrate fluid manifold 288. The second UV irradiation portion, in this embodiment, might employ UV radiation, as a disinfectant process to inactivate bacteria, viruses and other undesirable microorganisms, if present.

The controller 220, in one embodiment, includes logic that is controlled by an analog industrial PC touch screen control unit. Moreover, the controller 220 is configured to control each of the pumps, valves, sensors, motors, augers, etc. associated with each of the feeding system 230, mixing system 240, fermentation units 250, blending units 260, ventilation system 270, fluid manifolds 280 and fluid filters 290, 295, where needed. For example, in one embodiment the controller 220 includes pneumatic actuators configured to control pneumatic valves associated with each of the fermentation units 250, blending units 260, and fluid manifolds 280. Likewise, the controller 220 may include switches configured to control the electrical pumps (e.g., 3 phase electrical pumps) for each of the fermentation units 250 and blending units 260. Additionally, the controller 220 may have a remote interface (e.g., remote dial-up or Internet IP connection) such that the controller 220 may be operated off-site.

The feeding system 230, in the embodiment of FIG. 2, is configured to take feed, e.g. dry feed in one example, and provide it to one or more of the fermentation units 250 via the mixing system 240. In one embodiment, the feeding system 230 includes a loss-in-weight feeding system, as might be purchased from K-tron Process Group. For example, the loss-in-weight feeding system might comprise a custom automated digital modular gravimetric loss-in-weight feeding system, the output of which is controlled by the controller 220. Accordingly, the controller 220 would manage just how much feed is provided to each of the one or more fermentation units 250 via the mixing system 240 and the feed manifold 286.

Coupled to the feeding system 230, and more specifically in-line between the feeding system 230 and the fermentation units 250, is the mixing system 240. The mixing system 240 may comprise many different elements, however, in one specific embodiment the mixing system 240 comprises a radial mixer, which physically entrains the feed into fluid passing through the mixer on its way to the fermentation units 250 via the feed manifold 286.

Turning to FIG. 3, illustrated is an expanded view of a fermentation unit 300, which might be similar to one of the fermentation units 250 of FIG. 2. The fermentation unit 300 of FIG. 3 initially includes an enclosure 310. The enclosure 310, in one embodiment, is a standard 304 stainless steel enclosure. For example, in the embodiment shown, the enclosure 310 has a volume ranging from about 200 to about 500 gallons, in one embodiment a more specific range from about 300 to about 400 gallons, and in even another embodiment a more specific range of about 350 gallons.

Located within the enclosure 310 of the fermentation unit 300 is a front access point 320 as well as a top access point 330. The front access point 320, in one specific embodiment, is configured to allow the users of the system 100 to clean the inside of the enclosure 310, including the removal of any used up feed from therein. The top access point 330 has equally important functions.

Entering the upper portion of the enclosure 310 are two supply lines. The first supply line 340 is coupled through the feed manifold 286 (see FIG. 2) to the feeding system 230 and mixing system 240. Accordingly the first supply line 340 is configured to provide the feed that has been entrained within the liquid, to the enclosure 310. Coupled to the first supply line 340 is a valve 345. In the embodiment of FIG. 3, the valve 345 is a pneumatically controlled valve controlled by the controller 220.

In one embodiment, a mesh container is placed within the enclosure 310 to strain solid feed material from the incoming fluid from the feed manifold 286. The mesh container, in one embodiment, functions similar to a tea bag, thereby suspending the solid feed material within the enclosure 310. Accordingly, in this embodiment, the feed material is free to function as desired, however, any problems associated with the feed material stopping up the system is significantly reduced.

The second supply line 350, in the embodiment of FIG. 3, is configured to provide a liquid, such as tap water, spring water, health water, etc. into the enclosure 310. Similar to the first supply line 340, the second supply line 350 has a pneumatically controlled valve 355 associated therewith, for example controlled by the controller 220. Likewise, in one embodiment the second supply line 340 is coupled to the inlet fluid manifold 284.

The second supply line 350, in one embodiment, extends into the enclosure 310 a reasonable distance. For instance, the second supply line 350 might extend into the enclosure a distance such that the space between the outlet of the second supply line 350 and the inlet of a pump coupled to the enclosure 310 promotes fermentation. Additionally, an end of the second supply line 350 may have a feature so as to substantially prevent, if not entirely prevent, the mixing of the incoming fluid with the fluid already in the enclosure 310. In an ideal embodiment, a laminar boundary exists as the fluid enters the enclosure 310 from the second supply line 350, so as not to stir the feed located within the enclosure 310.

Additionally located within the upper surface of the enclosure 310 is an exhaust tube 360. The exhaust tube 360, in the embodiment shown, is coupled to the ventilation system 270 (see FIG. 2) via the exhaust manifold 282 (see FIG. 2). Accordingly, in one embodiment a slight negative pressure exists on the enclosure 310, such that the gasses from the fermentation process may be removed from the enclosure 310 (and for that matter from the fluid generation system 100), and thus not vented within the secure access container 110.

Additionally located on the upper surface of the enclosure 310 is a fluid level indicator 370. The fluid level indicator 370, in conjunction with the valve 355 and the controller 220 (see FIG. 2), is configured to make sure the appropriate amount of fluid is contained within the enclosure 310. Those skilled in the art understand the types of fluid level indicators that might be used.

As briefly indicated, a pump 380, and associated outlet line 385, are configured to take fermented liquid from the enclosure 310. The outlet line 385, in one embodiment, is positioned a predetermined distance above the bottom of the enclosure 310. For example, the predetermined distance is chosen based upon the desire to elevate the outlet line a sufficient distance, such that the feed becomes less of a problem, as well as to set the amount of time the liquid remains within the enclosure before being removed by the pump 380. Likewise, a filtering mechanism may be placed between the outgoing fluid and the pump 380 to remove any additional feed therefrom. In one embodiment, a wedge wire strainer is used as the filtering mechanism. Fluid exiting the enclosure 310 via the pump 380 may be placed on a common manifold (e.g., the concentrate fluid manifold 288) and directed toward on or more of the blending units 260.

In one example embodiment, the enclosure 310 and the associated pump 380 have difficulties with the feed clogging the filtering mechanism. In this embodiment, an opening in the upper portion of the back side of the enclosure is used to gravity feed the concentrate mixture from one of the fermentation units to another of the fermentation units so as to reduce the problems associated with the clogged filtering mechanism. In this embodiment, pumps associated with one of the later fermentation units that were gravity fed from the previous fermentation units, may then be used to place the concentrate fluid on the concentrate fluid manifold 288 as it heads for the blending units.

Turning now to FIG. 4, illustrated is an expanded view of a blending unit 400, which might be similar to one of the blending units 260 of FIG. 2. The blending unit 400 includes an enclosure 410 having a front access point 420 and top access point 430, which are substantially similar to the front access point 320 and top access point 330 of the enclosure 310 of FIG. 3. Entering the upper portion of the enclosure 410 are two supply lines. The first supply line 440, in the embodiment shown, is coupled to the concentrate fluid manifold 288, and thus outlet lines 385 (see FIG. 3) of the various fermenting units 250. In one embodiment, the concentrate fluid from the first supply line 440 enters the enclosure 410 at a variable, but measurable rate. Accordingly, a flow meter 445 may be coupled to the first supply line 440 for measurement thereof.

The second supply line 450, in the embodiment of FIG. 4, is configured to provide a liquid, such as tap water, spring water, health water, etc. into the enclosure 410. The second supply line 450, in one embodiment, has a pneumatically controlled valve 455 associated therewith. Accordingly, the valve 455 may be opened and closed to result in a predetermined concentration of liquid within the enclosure 410. For example, information from the flow meter 445 may be sent to the controller 220 (see FIG. 2) such that the controller 220 opens and/or closes the valve 455 to result in the desired concentration (e.g., amount of concentrate fluid to inlet fluid).

Additionally, a pump 480, and associated outlet line 485, may be configured to take the finished product from the enclosure 410. The finished product may then be run through the outgoing fluid filter (see FIG. 2) and stored offsite in larger containers.

A fluid generation system, such as the fluid generation system 100 of FIG. 1, may be operated in a number of manners. However, in one embodiment, a user of the system would place feed, in one embodiment dry feed, within the feeding system 230. The feeding system 230 would then weigh out the appropriate amount of feed into the mixing system 240, wherein the mixing system and liquid from the inlet manifold 284, would be combined onto a feed manifold 286 to be included within the one or more fermentation units 300 via the first supply line 340. At the same time, liquid from the inlet manifold 284 would enter the one or more fermentation units 300 via the second supply line 350. The mixture would then interact for the appropriate amount of time before the concentrate liquid is removed using the pump 380. The concentrated liquid may then be placed on the concentrate manifold 388 wherein it is provided to one or more of the blending units 400. Coincident with the concentrated mixture being included within the blending units 400, liquid from the inlet manifold 284 may also be included within the blending units. As previously indicated, the ratio of the concentrate liquid and liquid from the inlet manifold 284 may be adjusted to provide the appropriate mixture. Thereafter, the finished product may be passed through the outlet filter 295 to be stored offsite. In one embodiment, a final flow meter may be used to monitor the output of the final product.

The process, as discussed directly above, is intended to be a redundant process in one embodiment. For example, in one embodiment, any one of the fermentation units may be placed off-line for any amount of time so long as at least one fermentation unit is in operation. In this same embodiment, however, the blending units are operated in an either/or scenario. Accordingly, in one embodiment one of the blending units must be on-line if one or more of the fermentation units are on-line.

Other variations from the process described above exist. For example, in one embodiment, the rate at which the inlet liquid enters the fermentation units is substantially similar to the rate at which the concentrate liquid exits the fermentation units. Likewise, in other embodiments, if a situation occurs wherein the production cannot be continuous and thus the final product cannot go to the offsite storage, the product may be dumped to drain. Additionally, an embodiment exists where a backup generator may be used to account for those situations wherein power is lost to the system.

The pumps in the system, in one embodiment, are also designed for a soft start. For example, the soft start is designed to reduce the effect of the pump quickly coming to speed. In one embodiment, the pumps are designed to take approximately 90 seconds from start to reaching the operating frequency, 60 Hz in one embodiment. This helps reduce the agitation of the different types of fluids within the fermentation units.

In one embodiment, the process plumbing, valves and fittings are fabricated from food grade 304 SS. Likewise, the electrical connections may be wet contact safe for wash down. Additionally, interior fabrication may be finished out in FDA/NSF approved diamond plate flooring, siding and ceiling materials for contact sanitization procedures. Likewise, micron filtration and pumps station systems may be programmed to regulate flow and signal low/high pressure readings.

Attention will now turn to one embodiment of a control system (e.g., controller), as might be used with a fluid generation system in accordance with this disclosure. In one embodiment, the control system provides the Human-Machine Interface (HMI) that allows the operator to control the operation of the fluid generation system. In the disclosed embodiment, the control system for the fluid generation system may include one or more of the following: (1) Control panel with various switches and indicator lights, (2) Programmable Logic Controller (PLC), and (3) Supervisory Control And Data Acquisition system (SCADA).

For most pumping systems, a local control panel may be configured to provide switches for controlling the pumps manually. This panel may be mounted proximate the pumps or located centrally on a Motor Control Console (MCC). The panel may be as simple as a HAND/OFF/AUTO (or ON/OFF/AUTO) selector or it may contain a mixture of switches, indicator lights, pushbuttons, and instruments. Variable speed (Variable Frequency Drives or VFD's) may be controlled manually at the local control panel by opening the panel and manipulating the buttons on the VFD control module.

The Programmable Logic Controller (PLC), when used, may monitor the function of the fluid generation system and control its operation. Instruments measuring process parameters such as flow, pressure, temperature, and conductivity may be connected to the PLC. The PLC may then use the data collected from these instruments to control process equipment such as valves and pumps. Historical trends and real time trends of any of these instruments may also be displayed and analyzed. The PLC may also activate alarms or initiate a system shutdown when problems are detected. Any available manual functions of the PLC, in one embodiment, may be accessed through the local control panel or the motor starter panel. In smaller fluid generation systems one PLC may control the whole system. However, in larger fluid generation systems, multiple PLC's may communicate with the DCN and SCADA system. Each PLC may contain the instructions defining how its portion of the fluid generation system is to operate. The PLC's may each have a selector switch, which allows the PLC to accept signals from either (Remote) DCN, other PLC's and the SCADA, or to ignore all but shutdown and startup signals.

The SCADA system, when used, provides a sophisticated Human-Machine Interface (HMI). Each SCADA System, in one embodiment, is a Personal Computer (PC) that uses a powerful communication program to relay operator commands to the PLC. Measured information retrieved from the PLC may then be stored in the PC and displayed as the operator desires—such as historical trends and real-time trends. The SCADA System, in one embodiment, does not control the process, but only functions as an interface between the operator and the PLC(s). The SCADA System PC may be located in a separate freestanding control panel or mounted as part of an existing panel. In some systems there are even redundant SCADA PCs. A modular bus network, in one embodiment, connects the PLC system(s) and the SCADA System(s) together. When there are two SCADA controllers, there is often a Local Area Network (LAN) connection between the two SCADA Systems.

The fluid generation system may be configured to operate in three distinct modes: (1) automatic operating mode, (2) service operating mode, or (3) manual operating mode. In automatic operating mode, the fluid generation system operates without interference from the operator. For instance, in automatic mode the system operates based on input signals to the system PLC from the sensors and the Distributive Control System (DCS). The PLC may then report the sensor readings to the SCADA, which in turn may display and store the information for the operator to view and recall as needed. In one embodiment, during a start up, shutdown, or any other operation, the PLC steps the equipment through the necessary sequences, automatically performing and monitoring all steps required without operator involvement. The fluid generation system PLC may be tied electronically to other parts of a related fluid treatment plant, and therefore may resolve all communication and control of other equipment feeding fluid to, and receiving fluid from, the fluid generation system.

In the service operating mode, the PLC may resolve all local interlocks, safeties, permissives, sequences, shutdowns, restarts, etc., related to the fluid generation system without human intervention. However, in one embodiment, the PLC does not accept signals from the Distributive Control System. In this mode, the fluid generation system PLC might only resolve controls and interlocks associated with the local PLC. All setpoint parameters entered through the SCADA system may then be used for controlling the systems, but typically no network communication is accepted either from the DCS or any other control center.

In the manual operating mode (e.g., also described as semi automatic mode), the operator may start and stop the pumps and make adjustments to the fluid generation system as required. However, the PLC may still actually control the system. The interface signals that are used by the operator such as the SCADA and the panel switches may be signals transmitted to the PLC controller. The PLC may then step the equipment as directed by the operator. In this pseudo manual mode the interlocks and safeties, may still be controlled by the PLC. If the system detects an alarm or shutdown condition the PLC will likely override the operators request and shut the system down. Prior to operating the equipment any further, the operator should correct the shutdown condition and reset the alarm. The limited control offered by the pseudo manual mode is often for maintenance and troubleshooting purposes, and designed to help prevent damage to the equipment. Traditionally, the fluid generation system is not operated in manual operating mode during production.

Those skilled in the art to which this application relates will appreciate that other and further additions, deletions, substitutions and modifications may be made to the described embodiments.

What is claimed is:

1. A fluid generation system, comprising:
an inlet fluid manifold coupleable to an inlet fluid source;
a feed manifold coupled to an output of a feeding/mixing system;
two or more fermentation units, wherein an inlet of each of the two or more fermentation units is coupled to the feed manifold and an outlet of each of the two or more fermentation units is coupled to a concentrate fluid manifold;
two or more blending units, wherein a first inlet of each of the two or more blending units is coupled to the concentrate fluid manifold and a second inlet of each of the two or more blending units is coupled to the inlet fluid manifold, and furthermore wherein an outlet of each of the two or more blending units is coupleable to an outlet fluid source; and
a controller for controlling/monitoring a flow of fluid from the feed manifold to the two or more fermentation units and a flow of fluid from the concentrate fluid manifold and inlet fluid manifold to the two or more blending units, respectively.

2. The fluid generation system as recited in claim 1, wherein the inlet of each of the two or more fermentation units is a first inlet, and further including a second inlet of each of the two or fermentation units coupled to the inlet fluid manifold.

3. The fluid generation system as recited in claim 2, further including valves positioned between the feed manifold and each of the two or more fermentation units, between the inlet fluid manifold and the two or more fermentation units, and between the inlet fluid manifold and the two or more blending units.

4. The fluid generation system as recited in claim 3, wherein the valves are pneumatic valves controlled by the controller.

5. The fluid generation system as recited in claim 3, further including flow meters positioned between the concentrate fluid manifold and each of the blending units, the flow meters monitored by the controller.

6. The fluid generation system as recited in claim 1, wherein the feeding/mixing system includes a separate feeding system and separate mixing system.

7. The fluid generation system as recited in claim 6, wherein the mixing system is coupled to the inlet fluid manifold for providing mixing fluid thereto.

8. The fluid generation system as recited in claim 6, wherein the feeding system is a loss-in-weight feeding system, and the mixing system is a radial mixer.

9. The fluid generation system as recited in claim 1, further including an outgoing fluid filter positioned between the outlet fluid source and outlets of the two or more blending units.

10. The fluid generation system as recited in claim 1, further including a fluid level indicator associated with each of the two or more fermentation units, the fluid level indicators monitored by the controller.

11. The fluid generation system as recited in claim 1, wherein the inlet fluid manifold, feed fluid manifold, concentration fluid manifold, two or more fermenting units, and two or more blending units are located within a single enclosure.

12. The fluid generation system as recited in claim 11, further including a ventilation system within the single enclosure.

13. The fluid generation system as recited in claim 12, wherein the ventilation system includes an exhaust manifold, and further wherein a second outlet of each of the two or more fermentation units is coupled to the exhaust manifold.

14. The fluid generation system as recited in claim 12, wherein the ventilation system is configured to maintain a negative pressure on the two or more fermentation units during the operation thereof.

15. The fluid generation system as recited in claim 11, wherein the single enclosure includes an integrated drain system.

16. The fluid generation system as recited in claim 15, wherein a floor of the single enclosure is configured to tilt toward the integrated drain system when the fluid generation system is in use.

17. The fluid generation system as recited in claim 11, wherein the single enclosure includes a door protected by a security mechanism configured to restrict access to the single enclosure.

18. The fluid generation system as recited in claim 17, wherein the security mechanism monitors at least one of the date, time or identity of ones gaining access to the single enclosure.

19. The fluid generation system as recited in claim 17, wherein the security mechanism may be monitor offsite.

20. The fluid generation system as recited in claim 11, wherein the single enclosure is portable.

21. The fluid generation system as recited in claim 11, wherein a mesh container is positioned within each of the fermentation units, the mesh container configured to strain solid matter from fluid entering the fermentation units from the feed manifold.
